(19) United States
(12) Patent Application Publication
(10) Pub. No.: US 2026/0073020 A1
(43) Pub. Date: Mar. 12, 2026

(54) LARGE LANGUAGE MODEL FOR FINANCIAL NEWS EVENTS DETECTION AND CATEGORIZATION

(71) Applicant: S&P Global Inc., New York, NY (US)

(72) Inventors: Urjitkumar Patel, Scotch Plains, NJ (US); Fang-Chun Yeh, New York, NY (US); Chinmay Gondhalekar, Jersey City, NJ (US); Hari Nalluri, New York, NY (US)

(21) Appl. No.: 18/828,727

(22) Filed: Sep. 9, 2024

(51) Int. Cl. G06F 18/2431; G06N 3/045; G06N 3/0985

(52) U.S. Cl. CPC G06F 18/2431; G06N 3/045; G06N 3/0985

(57) ABSTRACT

An illustrative embodiment provides a computer-implemented method. The method comprises using a processor set to train a first classification model using a first training dataset. The processor set receives a number of news articles from a plurality of data sources. The processor set classifies the number of news articles using the first classification model to generate a second training dataset. The processor set trains a second classification model using the first training dataset and the second training dataset. The processor set adjusts parameters for the second classification model based on a combination of optimization techniques to generate an improved classification model.

### BACKGROUND INFORMATION

### 1. Field

The present disclosure relates generally to natural language processing, and more specifically to generating large language models for article classification.

### 2. Background

Nowadays, the vast and varied nature of activities in the world continually generates a stream of news articles, making it challenging to stay updated and effectively manage information. The sheer volume of data from all kinds of activities can overwhelm traditional analysis methods and impact strategic decision-making across different sectors in different industries.

News article classification usually involves categorizing news articles into predefined categories or topics based on content for the news articles. This task is essential for organizing a large volume of news data that can be used to enable easier navigation and retrieval of information for both users and automated systems.

In this case, timely and accurate classification of news articles is paramount since news articles are crucial in delivering real-time information that influences investor decisions and market dynamics.

### SUMMARY

An illustrative embodiment provides a computer-implemented method. The method comprises using a processor set to train a first classification model using a first training dataset. The processor set receives a number of news articles from a plurality of data sources. The processor set classifies the number of news articles using the first classification model to generate a second training dataset. The processor set trains a second classification model using the first training dataset and the second training dataset. The processor set adjusts parameters for the second classification model based on a combination of optimization techniques to generate an improved classification model.

Another illustrative embodiment provides a computer system. The system comprises a processor set, a set of one or more computer-readable storage media, and program instructions stored on the set of one or more storage media to cause the processor set to perform operations comprising training a first classification model using a first training dataset; receiving a number of news articles from a plurality of data sources; classifying the number of news articles using the first classification model to generate a second training dataset; training a second classification model using the first training dataset and the second training dataset; and adjusting parameters for the second classification model based on a combination of optimization techniques to generate an improved classification model.

Another illustrative embodiment provides a computer program product. The computer program product comprises a set of one or more computer-readable storage media, and program instructions stored in the set of one or more storage media to perform operations comprising using a processor set to train a first classification model using a first training dataset; receiving a number of news articles from a plurality of data sources; classifying the number of news articles using the first classification model to generate a second training dataset; training a second classification model using the first training dataset and the second training dataset; and adjusting parameters for the second classification model based on a combination of optimization techniques to generate an improved classification model.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a model management environment in accordance with an illustrative embodiment;

FIG. 3A depicts base BERT model to which the illustrative embodiments can be applied;

FIG. 3B depicts a schematic diagram of a Financial Activity News Alerting Language Model (FANAL) model in accordance with an illustrative embodiment;

FIG. 4A-4B depicts an illustration of hyperparameters and performance plots for the FANAL model in accordance with an illustrative embodiment;

FIG. 5 depicts an example table of performance for the FANAL model in accordance with an illustrative embodiment;

FIG. 6 depicts a flowchart illustrating a process for generating a model for classifying news articles in accordance with an illustrative embodiment;

FIG. 7 depicts a flowchart illustrating a process for classifying news articles in accordance with an illustrative embodiment;

FIG. 8 depicts a flowchart illustrating a process for notifying users with classified articles in accordance with an illustrative embodiment;

FIG. 9 is a block diagram of a data processing system in accordance with an illustrative embodiment.

### DETAILED DESCRIPTION

The illustrative embodiments recognize and take into account a number of considerations. For example, the illustrative embodiments recognize and take into account that advancements in NLP (natural language processing), particularly through transformer-based models, have significantly enhanced the ability to process complex datasets.

The illustrative embodiments recognize and take into account that despite capabilities of the transformer-based models, high computational demands, infrastructure costs, and API service fees associated with deployment and uses of such transformer-based models often make the transformer-based models impractical for many applications.

The illustrative embodiments also recognize and take into account that a cost-effective and robust alternative with superior classification performance with minimal training data can be achieved by leveraging advanced fine-tuning techniques.

Thus, illustrative embodiments of the present invention provide a computer implemented method, computer system, and computer program product for generating a model for classifying news articles. The method comprises using a processor set to train a first classification model using a first training dataset. The processor set receives a number of news articles from a plurality of data sources. The processor set classifies the number of news articles using the first classification model to generate a second training dataset. The processor set trains a second classification model using the first training dataset and the second training dataset. The processor set adjusts parameters for the second classification model based on a combination of optimization techniques to generate an improved classification model.

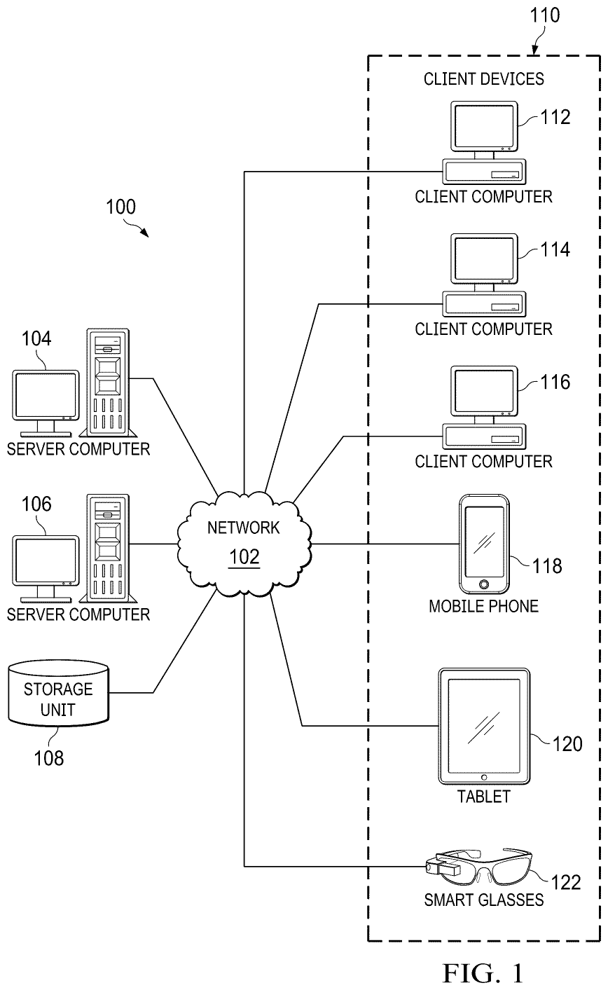

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 includes client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

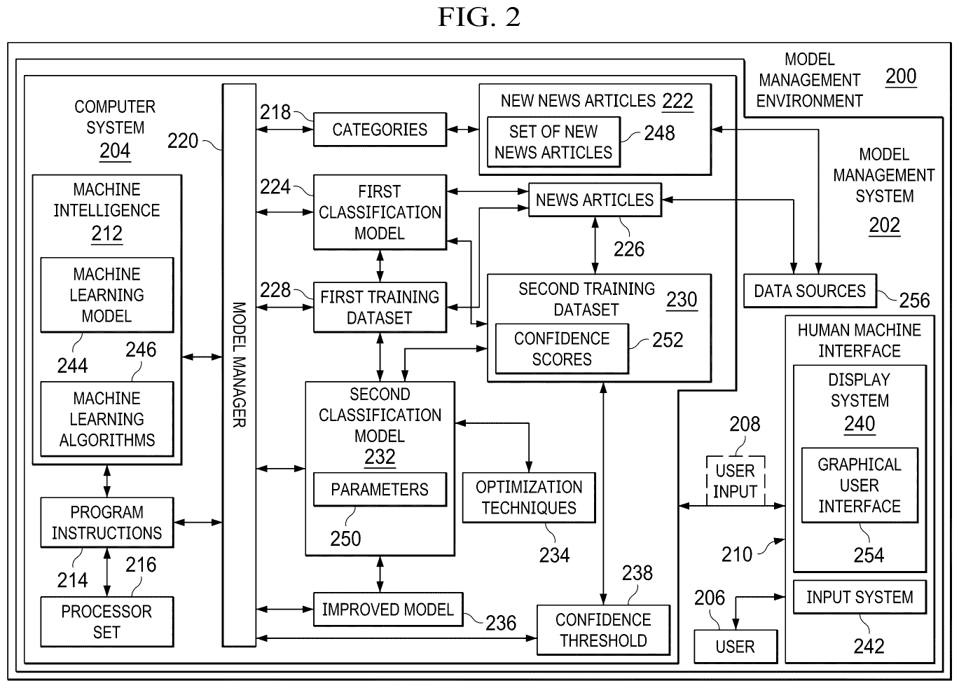

With reference now to FIG. 2, an illustration of a block diagram of a model management environment is depicted in accordance with an illustrative embodiment. In this illustrative example, model management environment 200 includes components that can be implemented in hardware such as the hardware shown in network data processing system 100 in FIG. 1.

In this illustrative example, model management system 202 in model management environment 200 uses optimization techniques 234 to finetune parameters 250 in second classification model 232 for generating improved model 236. In this illustrative example, model management system 202 includes computer system 204 which includes model manager 220. Model manager 220 is located in computer system 204.

Model manager 220 can be implemented in software, hardware, firmware, or a combination thereof. When software is used, the operations performed by model manager 220 can be implemented in program instructions configured to run on hardware, such as a processor unit. When firmware is used, the operations performed by model manager 220 can be implemented in program instructions and data and stored in persistent memory to run on a processor unit. When hardware is employed, the hardware can include circuits that operate to perform the operations in model manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

In addition, “optimize” and “finetune” in this context refers to the process of adjusting parameters in machine learning models for improving the machine learning models to achieve better efficiency and accuracy.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In addition, computer system 204 includes machine intelligence 212. Machine intelligence 212 can include machine learning model 244 and machine learning algorithms 246. Machine learning model 244 is a branch of artificial intelligence (AI) that enables computers to detect patterns and improve performance without direct programming commands. Rather than relying on direct input commands to complete a task, machine learning model 244 relies on input data. The data is fed into the machine, one of machine learning algorithms 246 is selected, parameters for the data are configured, and the machine is instructed to find patterns in the input data through optimization algorithms. The data model formed from analyzing the data is then used to predict future values.

Machine intelligence 212 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 212.

Machine intelligence 212 can be implemented using one or more systems such as an artificial intelligence system, a neural network, a generative neural network, a Bayesian network, an expert system, a fuzzy logic system, a genetic algorithm, or other suitable types of systems. Machine learning model 244 and machine learning algorithms 246 may make computer system 204 a special purpose computer for generating first classification model 224, second classification model 232, and improved model 236.

Machine learning model 244 involves using machine learning algorithms 246 to build computation models based on samples of data. The samples of data used for training are referred to as training data or training datasets. Machine intelligence 212 can make predictions without being explicitly programmed to make these predictions. Machine intelligence 212 can be used for training and retraining computation models for a number of different types of applications. These applications include, for example, medicine, financial services, healthcare, speech recognition, computer vision, or other types of applications.

In this illustrative example, machine learning algorithms 246 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

In this illustrative example, computer system 204 includes news articles 226 from data sources 256. In this illustrative example, data sources 256 are a plurality of platforms that provide news articles as they are published. For example, data sources 256 can include online news websites, news aggregators, social medias, or any suitable digital or non-digital platform that provides up to date news articles.

In this illustrative example, a portion of news articles 226 can be manually classified by experts in a field to generate first training dataset 228. In this example, first training dataset 228 is referred to as the “gold standard” dataset. In other words, the “gold standard” dataset in news articles 226 is highly reliable and can be used as a benchmark for training, evaluating, and validating machine learning models.

In this illustrative example, model manager 220 can train first classification model 224 using first training dataset 228 and machine intelligence 212. In this illustrative example, first classification model 224 can be a classification model that employs a classification algorithm such as XGBoost algorithm, decision trees algorithm, random forest algorithm, logistic regression algorithm, LightGBM algorithm, or any suitable algorithm.

The illustrative embodiments employ XGBoost algorithm for labeling dataset due to XGBoost's performance and efficiency with smaller datasets. XGBoost optimizes this objective function:

$$O bj = {\sum }_{i = 1}^{n} l ( {y}_{i} , y \hat{} i ) + {\sum }_{K = 1}^{K} Ω ( f k ) \qquad ( 1 )$$

where l measures prediction discrepancies, and Ω includes regularization to prevent overfitting. In this illustrative example, XGBoost's meticulous management of learning rates and column sampling allows it to effectively identify complex patterns and maintain consistency, making it effective for silver labeling in financial news.

In this illustrative example, first classification model 224 is trained with first training dataset 228 such that first classification model 224 is capable of classifying news articles in news articles 226 with accuracy.

After training, model manager 220 uses first classification model 224 to classify other news articles in news articles 226 to generate second training dataset 230. In this illustrative example, other news articles in news articles do not include news articles from first training dataset 228.

Model manager 220 can determine a confidence threshold such as confidence threshold 238 for generating second training dataset 230. In this illustrative example, model manager 220 computes a confidence score for each news article that can be potentially included in second training dataset 230. Model manager 220 selects news articles that have confidence scores exceeding confidence threshold 238 for generating second training dataset 230. In other words, second training dataset 230 only includes news articles with confidence scores in confidence scores 252 that exceed confidence threshold 238. In this illustrative example, second training dataset 230 can be referred to as “silver label” dataset.

Silver labeling is an innovative technique situated between gold standard annotations and unsupervised predictions to broaden the training dataset beyond manual annotations. It is particularly valuable in scenarios where acquiring labeled data is cost-prohibitive or logistically challenging.

In this illustrative example, model manager 220 uses machine intelligence 212 to train second classification model 232 based on first training dataset 228 and second training dataset 230. In this illustrative example, second classification model 232 can be a large language model (LLM), which is an artificial intelligence model that understands human language to perform tasks. For example, second classification model 232 can be a Bidirectional Encoder Representation from Transformers (BERT)-based language model, or a suitable transformer architecture-based model.

In this illustrative example, model manager 220 can adjust a portion or all parameters in parameters 250 for second classification model 232 using optimization techniques 234. Optimization techniques 234 are finetuning techniques for machine learning models that improve model performance. In this illustrative example, optimization techniques 234 can include a first optimization technique that adjusts parameters in parameters 250 for all layers of second classification model 232. For example, the first optimization technique can be Full BERT fine-tuning using Cross-Entropy Loss.

In addition, optimization techniques 234 can include a second optimization technique that optimizes loss function for second classification model 232. For example, the second optimization can be Full BERT fine-tuning using the ORPO (Odds Ratio Preference Optimization) loss method.

In this illustrative example, ORPO loss method has advantages in handling class imbalances and specific prediction preference by directly addressing class distribution by optimizing class odds ratios.

Further, optimization techniques 234 can include a third optimization technique that adjusts a portion of parameters in parameters 250 while keeping other parameters in parameters 250 fixed for second classification model 232. For example, the first optimization technique can be integration of PEFT (Parameter-Efficient Fine-Tuning) with LORA (Low-Rank Adaptation).

In this illustrative example, model manager 220 can select any technique from optimization techniques 234 or select a combination of optimization techniques that includes at least two optimization techniques from optimization techniques 234.

When a combination of optimization techniques is used, model manager 220 can apply optimization techniques from the combination of optimization techniques to second classification model 232 in a sequential manner. In an alternative illustrative example, model manager 220 can apply optimization techniques from the combination of optimization techniques to second classification model 232 individually and select the resulting classification model with best performance for future classification tasks.

In this illustrative example, model manager 220 generates improved model 236 after applying optimization techniques 234 to second classification model 232. In this illustrative example, improved model 236 can be used for classifying news articles.

For example, improved model 236 can be used for classifying new news articles 222 from data sources 256 in real-time as new news articles 222 are published. In this illustrative example, improved model 236 can classify new news articles 222 into different categories in categories 218.

For example, if news articles 226 and new news articles 222 are news articles related to the financial sector, improved model 236 will be trained and optimized for classifying financial news articles. In this example, categories 218 can include twelve distinct categories: Merge and Acquisition (M&A), Public Market Finance, Private Placement, Initial Public Offering (IPO), Strategic Alliances, Company Reorganization and Structure Change, Spin-Off/Split-Off, Dividend, Credit Rating, Debt Default, Bankruptcy, and others.

The category of M&A encompasses news articles that relate to the process of combining two or more companies through various types of financial transactions, such as mergers, acquisitions, consolidations, and takeovers.

The category of Public Market Finance pertains to news articles that refer to both borrowing money that must be rapid over time and the raising of capital by companies through the sale of securities such as stocks or bonds to the public on stock exchanges or other public markets.

The category of Private Placement encompasses news articles that relate to the sale of stocks, bonds, or securities directly to a private investor, rather than as part of a public offering.

The category of IPO pertains to news articles that relate to the process through which a privately held company offers its shares to the public for the first time, allowing the privately held company to raise capital from public investors.

The category of Strategic Alliance encompasses news articles that relate to collaborative agreements between independent entities aimed at achieving mutually beneficial objectives through shared resources and capabilities.

The category of Company Reorganization and Structure Change pertains to news articles that relate to the process of modifying a company's organizational setup and operational framework to adapt to market dynamics or achieve strategic goals.

The category of Spin-Off/Split-Off encompasses news articles that relate to the creation of a new, independent company through the sale or distribution of shares of an existing business division or subsidiary to shareholders.

The category of Dividend pertains to news articles that relate to a payment made by a corporation to its shareholders, usually in the form of cash or additional shares, representing a portion of the company's profits.

The category of Credit Rating encompasses news articles that relate to an assessment of the creditworthiness of a borrower, usually issued by credit rating agencies to indicate the likelihood that the borrower will repay its debt obligations in a timely manner.

The category of Debt Default pertains to news articles that relate to events that occur when a borrower fails to meet its contractual obligations to repay its debt, such as failing to make interest or principal payments when due.

The category of Bankruptcy encompasses news articles that relate to a legal process through which individuals or businesses that cannot repay their debts seek relief from some or all of their debts, usually through liquidation of assets or reorganization of debts under court supervision.

The “Other” category encompasses a diverse range of articles, including reports, studies, educational content, guidance materials, and miscellaneous topics related to a variety of financial events or instruments not covered by the above categories, such as launching new products, additions to an index, and educational content.

One of the primary challenges in financial news classification is managing class imbalances. Certain categories may naturally occur more frequently than others, which can lead to a bias in predictions. Traditional fine-tuning methods, such as those based solely on Cross-Entropy Loss, often struggle in these scenarios because they tend to favor the more frequent classes, resulting in lower recall for less frequent classes.

In this illustrative example, ORPO loss method may be superior to other optimization techniques because ORPO loss method introduces a penalty based on the odds ratio that inherently accounts for the relative frequency of categories. By focusing on adjusting predictions according to these odds ratios, ORPO loss method can ensure that the dominant categories are not disproportionately favored.

Instead, the ORPO loss method encourages a more balanced performance across all categories, particularly improving recall for underrepresented categories. In addition, ORPO loss method enhances the distinction between categories by optimizing the model to recognize and amplify the differences between categories such that the likelihood of misclassification in closely related categories is reduced.

As depicted, model manager 220 can use improved model 236 to classify new news articles 222 into categories 218 in real-time as new news articles 222 are published. In this illustrative example, new news articles 222 can further be clustered together based on companies, tags, and event types after classification.

In this illustrative example, set of new news articles 248 that are classified and clustered using the method described above can be sent to users based on preferences for the users.

In this illustrative example, users such as user 206 can interact with computer system 204 through user inputs to computer system 204. For example, computer system 204 can receive user input 208 that includes user preferences, confidence threshold 238, predefined categories for categories 218, and other commands that are related to the generation of models and classification of news articles.

In this illustrative example, user input 208 can be generated by user 206 using human machine interface (HMI) 210. As depicted, human machine interface 210 includes display system 240 and input system 242. Display system 240 is a physical hardware system and includes one or more display devices on which graphical user interface 254 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 254 through user input 208 generated by input system 242. Input system 242 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view categories 218, set of new news articles 248, parameters 250, and confidence threshold 238 using graphical user interface 254 in display system 240.

In one illustrative example, one or more solutions are present that overcome a problem with classifying news articles. As a result, one or more technical solutions may provide an ability to increase the efficiency for classifying news articles in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 220 in computer system 204 enables generation of improved model 236 for classifying news articles such as new news articles 222. In particular, model manager 220 transforms computer system 204 into a special purpose computer system as compared to currently available general computer systems that do not have a model manager 220.

In the illustrative example, the use of model manager 220 in computer system 204 integrates processes into a practical application for classifying news articles because model manager 220 improves efficiency and accuracy of classifying news articles such that performance of computer system 204 can be increased. In other words, model manager 220 in computer system 204 is directed to a practical application of processes integrated into model manager 220 in computer system 204 that classifies news articles in an accurate and efficient manner.

The approach discussed above systematically organizes and analyzes the vast array of incoming news articles, enabling a more focused and efficient method for classifying news articles. The illustrative embodiments achieve these objectives using a practical, efficient, and cost-effective approach, distinguishing it from the more expensive Large Language Models (LLMs).

In this illustrative example, the optimization strategy mentioned above improves the model's capability to handle class imbalances and refine predictions according to desired class distributions. By efficiently sorting these articles into relevant categories, the illustrative embodiments seek to enhance the utility and accessibility of financial news, making it more actionable for financial professionals and organizations.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, optimization techniques can also include other types of optimization techniques.

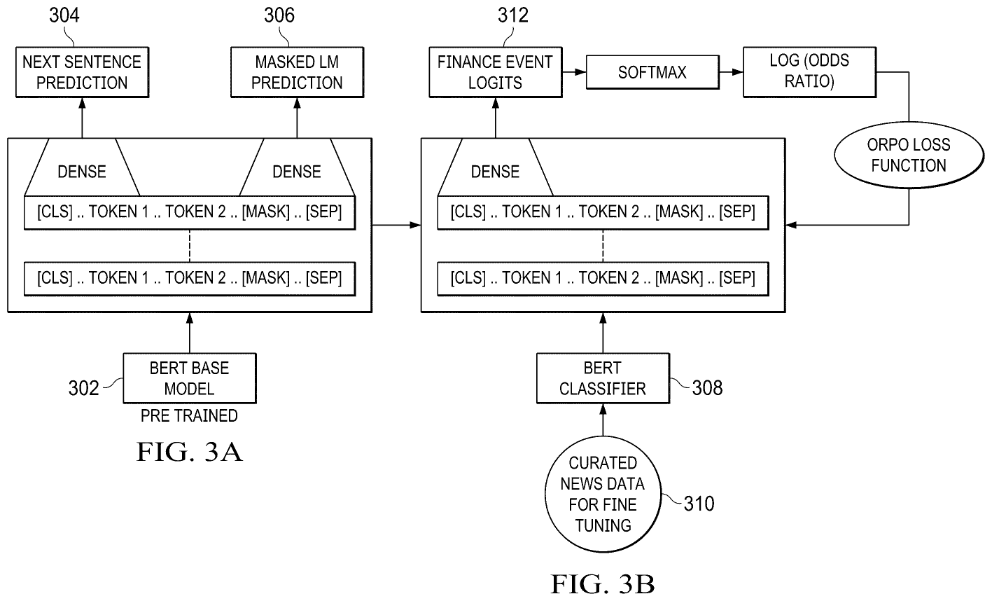

FIG. 3A depicts base BERT model to which the illustrative embodiments can be applied. FIG. 3B depicts a schematic diagram of a Financial Activity News Alerting Language Model (FANAL) model in accordance with an illustrative embodiment. In this illustrative example, the FANAL model can be an example of improved model 236 in FIG. 2.

As depicted, FIG. 3A outlines the BERT Base Model structure 302, showcasing its dual training objectives: Next Sentence Prediction 304 and Masked Language Model (LM) Prediction 306. These components process sequences of tokenized inputs, each sequence initiated with a [CLS] token and interspersed with [SEP] tokens.

The BERT model processes these inputs through multiple layers of transformer encoders. For classification, the output corresponding to the [CLS] token is passed through a classification layer to predict the label using a softmax function, and the model is finetuned by minimizing the Cross-Entropy loss using optimization algorithms such as Adam optimizer.

In this illustrative example, Cross-Entropy Loss (Log Loss) quantifies the difference between predicted and actual class probabilities.

$$Log Loss = - \frac{1}{N} {\sum }_{i = 1}^{N} {\sum }_{j = 1}^{M} {y}_{ij} log ( {p}_{ij} ) \qquad ( 2 )$$

FIG. 3B depicts the BERT Classifier 308, which has been fine-tuned from the BERT base model 302 in FIG. 3A using a curated dataset 310 specific to financial news for enhanced classification accuracy. The classifier also processes tokenized inputs through dense layers, ultimately yielding classified finance event outputs 312. This schematic encapsulates the model's initial pre-training on diverse language data followed by its subsequent specialization through fine-tuning for cyber threat detection and classification.

In FIG. 3B, several fine-tuning techniques were used to optimize model's performance including Full BERT fine-tuning using Cross-Entropy loss, Full BERT fine-tuning using ORPO (Odds Ratio Preference Optimization) loss method, and the integration of PEFT (Parameter-Efficient Fine-Tuning) with LORA (Low-Rank Adaptation).

Parameter-Efficient Fine-Tuning (PEFT) is known for its efficiency in fine-tuning large LLMs. While full fine-tuning updates all parameters, partial fine-tuning in PEFT selectively freezes a portion of the model's weights while fine-tuning the rest. The fine-tuning process for both full and partial parameter updates explore the performance impact on multiclass classification tasks, providing insights into the trade-offs between computational efficiency and classification effectiveness.

PEFT can be combined with Low-Rank Adaptation (LORA). LoRA updates a pre-trained weight matrix W₀ with a low-rank decomposition W₀+ΔW=W₀+BA, where Bϵ [symbol] ^{dxr} and Aϵ [symbol] ^{rxk}, and the rank r«min(d,k). As shown in FIG. 3, during training, W₀ is frozen, while A and B contain trainable parameters. The modified forward pass with LORA is:

$$h = {W}_{{0}^{x}} + Δ W x = {W}_{{0}^{x}} + B A x \qquad ( 3 )$$

where x is the input feature vector, and h is the output feature vector.

This approach integrates BERT's architecture with PEFT and LoRA fine-tuning for effective cyber multiclassification.

An Entity Relevance Module may form part of the system to enhance the processing of news articles by determining the contextual relevance of identified entities within the text. Unlike standard Named Entity Recognition (NER) models that simply tag entities, this module assesses their contextual significance within the news titles.

For instance, in the statement “Debt defaults soared, XYZ says”, where “XYZ” is recognized as a commentator rather than the main subject.

The model applies a sigmoid function to determine the probability of relevance:

$$P ( Class 1 - Relevant ) = σ ( W \cdot ϕ ( input ) + b ) \qquad ( 4 )$$

where σ denotes the sigmoid activation function, W and b are the model weights and bias, and Φ(input) is the feature representation of the input.

The Entity Relevance Module is trained on labeled data, producing probabilities that contribute to nuanced entity-centric analysis.

As depicted, the Odds Ratio Preference Optimization (OPRO) loss method can be applied for full BERT fine-tuning. This approach optimizes the training process for robustness and performance, potentially resulting in better generalization on unseen data.

In this illustrative example, OPRO enhances fine-tuning by integrating an odds ratio-based penalty with the conventional negative log-likelihood (NLL) loss. This method differentiates between favored and disfavored responses without needing a reference model.

In this illustrative example, ORPO begins by receiving an input sequence x (the sequence of tokens provided to the model), the average log-likelihood of generating an output sequence y (the predicted sequence of tokens) of length m (the number of tokens in the output sequence) is:

$$log {P}_{θ} ( y \vert x ) = \frac{1}{m} {\sum }_{t = 1}^{m} {P}_{θ} ( {y}_{t} \vert x , y < t ) \qquad ( 5 )$$

where Pθ (y|x) is the probability of generating the sequence y given the input x, and yt is the token at position t in the sequence y, and y<t represents the tokens before position t.θ: Model parameters (weights and biases).

The odds of generating y given x is:

$${odds}_{θ} ( y \vert x ) = \frac{{P}_{θ} ( y \vert x )}{1 - {P}_{θ} ( y \vert x )} \qquad ( 6 )$$

The odds ratio between a chosen response yw (a favored response) and a rejected response yl (a disfavored response) is:

$$0 {R}_{θ} ( {y}_{w} , {y}_{l} ) = \frac{{odds}_{θ} ( {y}_{w} \vert x )}{o d d {s}_{θ} ( {y}_{l} \vert x )} \qquad ( 7 )$$

The ORPO objective combines the supervised fine-tuning (SFT) loss and the relative ratio loss:

$${L}_{ORPO} = {E}_{x , {y}_{w} , {y}_{l}} [ {L}_{SFT} + λ \cdot {L}_{OR} ] \qquad ( 8 )$$

where L_{SPT} is the conventional NLL loss and A is a scaling factor. The SFT loss is the conventional NLL loss:

$${L}_{SFT} = log {P}_{θ} ( y \vert x ) \qquad ( 9 )$$

The relative ratio loss LOR maximizes the odds ratio between the favored and disfavored responses:

$${L}_{O R} = - log σ ( log \frac{{odds}_{θ} ( {y}_{w} \vert x )}{o d d {s}_{θ} ( {y}_{l} \vert x )} ) \qquad ( 10 )$$

where σ denotes the sigmoid function.

In this illustrative example, the Cross-Entropy loss focuses on minimizing the difference between predicted and true labels. In contrast, ORPO not only incorporates this but also penalizes the model for generating less favored responses to ensure a preference alignment.

In this illustrative example, the gradient of the ORPO objective includes terms that penalize incorrect predictions and contrast chosen and rejected responses:

$${∇}_{θ} {L}_{O R} = δ ( d ) \cdot h ( d ) \qquad ( 11 )$$

where

$$δ ( d ) = {[ 1 + \frac{{odds}_{θ} ( {y}_{w} \vert x )}{o d d {s}_{θ} ( {y}_{l} \vert x )} ]}^{- 1} \qquad ( 12 )$$

and

$$h ( d ) = \frac{{∇}_{θ} log {P}_{θ} ( {y}_{w} \vert x )}{1 - {P}_{θ} ( {y}_{w} \vert x )} - \frac{{V}_{θ} log {P}_{θ} ( {y}_{l} \vert x )}{1 - {P}_{θ} ( {y}_{l} \vert x )} \qquad ( 13 )$$

In this illustrative example, ORPO accelerates parameter updates when the model is more likely to generate rejected responses, ensuring efficient preference alignment and reducing computational overhead while maintaining high performance. In this illustrative example, the FANAL model that is fine-tuned using ORPO can also be referred to as BERT-based model fine-tuned with Odds Ratio Preference Optimization (ORBERT).

The dataset utilized for training FANAL model includes a “gold standard” dataset that consists of 1200 samples with 100 samples from each category for financial news articles. In this illustrative example, the “gold standard” dataset set was meticulously labeled by domain experts. This dataset facilitated the initial training of the XGBoost model using an 80%-20% training-testing split.

After the initial training phase, the XGBoost model is applied to the remaining data from data sources, excluding the previously used “gold standard” data. Records with high labeling confidence were selected to form the “silver label” dataset. This dataset comprised approximately 16,000 high-confidence records, which played a crucial role in further fine-tuning the BERT model.

In this illustrative example, the BERT-based model is fine-tuned to generate the FANAL model using both “gold standard” dataset and “silver labeled” dataset with 1,200 and 16,000 samples respectively to provide a substantial amount of training samples for each category.

In addition, the FANAL model is evaluated and benchmarked against other large language models (LLMs) by using a diverse subset of approximately 1,200 articles. This subset of articles, sampled from all three datasets, are labeled by subject matter experts (SMEs) to ensure that all categories were adequately represented, enhancing the reliability of our evaluation.

The illustration of computational models in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, other optimization techniques can be utilized for finetuning instead of using full BERT fine-tuning using Cross-Entropy loss, Full BERT fine-tuning using ORPO loss method, or the integration of PEFT with LoRA.

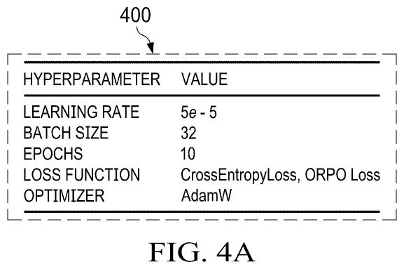

With reference now to FIG. 4A-4B, an illustration of hyperparameters and performance plots for the FANAL model is depicted in accordance with an illustrative embodiment. As depicted, the FANAL model can be an example of improved model 236 in FIG. 2.

The hyperparameters of the FANAL model are listed in the table shown in table 400 in FIG. 4A. In this illustrative example, a grid search is employed on a small subset of data to identify the best parameters and then applied these optimal settings for the full tuning of the FANAL model.

In this illustrative example, a series of four distinct BERT fine-tuning are performed, each with a specific configuration aimed at exploring the effects of using different optimization techniques on model performance, as illustrated in FIG. 4B. Plot 402 shows the results for the first run that involves a Parameter efficient fine-tuning (PeFT) approach with a Low-Rank Adaptation (LORA) with a rank of 8. Plot 404 shows results for the second run that involves full BERT fine-tuning using the ORPO loss method. Plot 406 shows results for the third run that comprehensive fine-tuning of the entire BERT model. Plot 408 shows the results for the fourth run that involves a Parameter efficient fine-tuning (PeFT) approach with a Low-Rank Adaptation (LORA) with a rank of 4.

In this illustrative example, LORA applies a low-rank decomposition to the weight matrices of a model, particularly in the layers that are being fine-tuned. Instead of updating the full weight matrix during fine-tuning, LORA introduces a pair of low-rank matrices that approximate the original weight updates. In other words, rank number for LORA determines how approximate the new weight matrices will be.

In this illustrative example, standard metrics such as precision, recall, F1-Score, and accuracy are used to evaluate performance of models with different optimization techniques. For example, precision can be calculated by:

$$Precision = \frac{True Positives}{True Positives + False Positives} \qquad ( 14 )$$

Recall measures the model's ability to identify all positive instances. Recall can be calculated by:

$$Recall = \frac{True Positives}{True Positives + False Negatives} \qquad ( 15 )$$

The F1-Score balances precision and recall, providing a comprehensive performance measure. F1-Score can be calculated by:

$$F 1 - Score = \frac{2 \cdot Precision \cdot Recall}{Precision + Recall} \qquad ( 16 )$$

Accuracy quantifies the overall correctness of the model's predictions. In this illustrative example, accuracy can be calculated by:

$$Accuracy = \frac{Number of Correct Predictions}{Total Number of Predictions} \qquad ( 17 )$$

In this illustrative example, the results shown in FIG. 4 indicate that different finetuning strategies can lead to varying rates of convergence and performance. The ORPO method and PEFT LORA achieved best validation loss at different epochs, while full BERT fine-tuning reached its optimal performance earlier. The results highlight the effectiveness of different fine-tuning strategies, with ORPO and PEFT LORA methods showing competitive performance with reduced computational costs compared to full BERT fine-tuning.

Upon analyzing the loss and F1 scores presented in FIG. 2 at each checkpoint across all models, it is evident that the comprehensive fine-tuning of the BERT model utilizing the ORPO loss function exhibited superior performance relative to other methodologies, as shown in plot 402. The emphasis was placed on absolute performance, wherein full fine-tuning with ORPO loss significantly outperformed alternative approaches. However, it is important to acknowledge that other configurations, such as fine-tuning only the LORA (rank=8) layer, also yielded notable results. These strategies are particularly advantageous in scenarios where computational resources are constrained or when dealing with exceedingly large models, making full fine-tuning impractical.

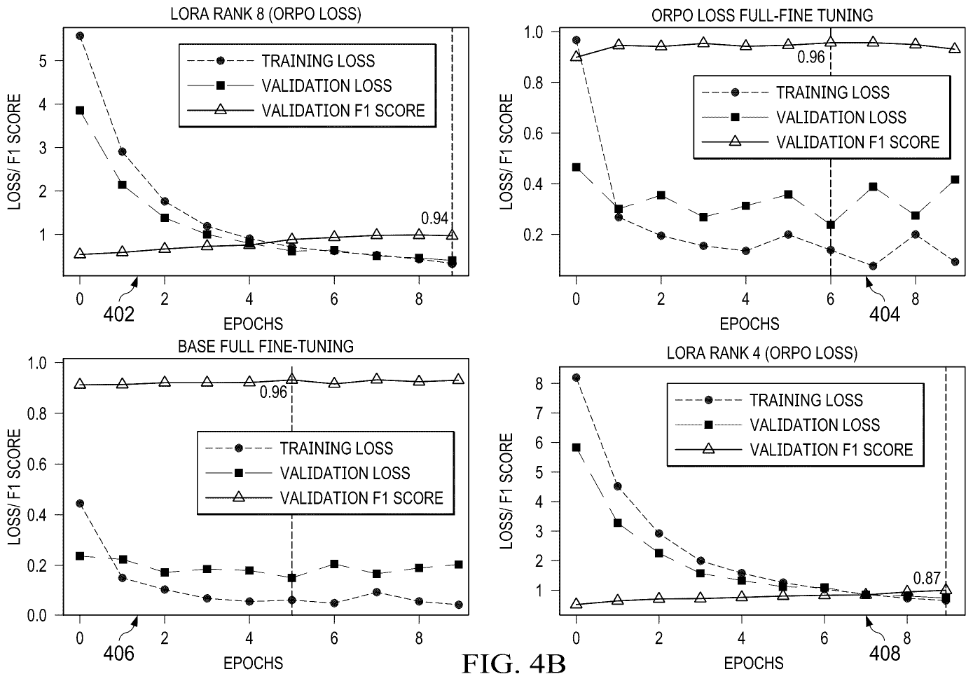

FIG. 5 depicts an example table of performance for the FANAL model in accordance with an illustrative embodiment. In this illustrative example, the FANAL model in FIG. 5 can be BERT-based model fine-tuned with Odds Ratio Preference Optimization (ORBERT). As depicted, the FANAL model can be an example of improved model 236 in FIG. 2.

In comparison between FANAL model and other expensive LLMs such as Large Language Model Meta AI-3.1 (Llama-3.1), Phi-3 FS, and Generative Pre-trained Transformer-40 (GPT-40), table 500 shows that the FANAL model emerges as the superior performer across almost all assessed categories.

The FANAL model stands out for its performance on categories such as Strategic Alliances, Bankruptcy, Dividend, Debt Default, Public Market Finance, and Private Placement. In this illustrative example, FANAL model consistently outperforms other models by significant margins in at least three out of four metrics.

When comparing the FANAL model to other models, GPT-4o emerges as the closest competitor. In this illustrative example, a close match can be observed in a few categories such as M&A and Spin-Off/Split-Off. FANAL model demonstrates higher accuracy, while GPT-4o achieves higher precision and F1 scores.

GPT-4o attains top performance, notably in the Credit Rating category, where it excels across all metrics. However, its performance varies significantly in categories like Public Market Finance and Debt Default, likely due to overlapping characteristics in the training data and possibly due to sensitivity to noise and outliers. In most cases, the FANAL model maintains high F1-scores that effectively balancing precision and recall as compared to Llama-3.1 and Phi-3 FS that indicate weaker performance in balancing precision and recall. However, Phi-3 exhibits notable precision in the IPO and Private Placement categories.

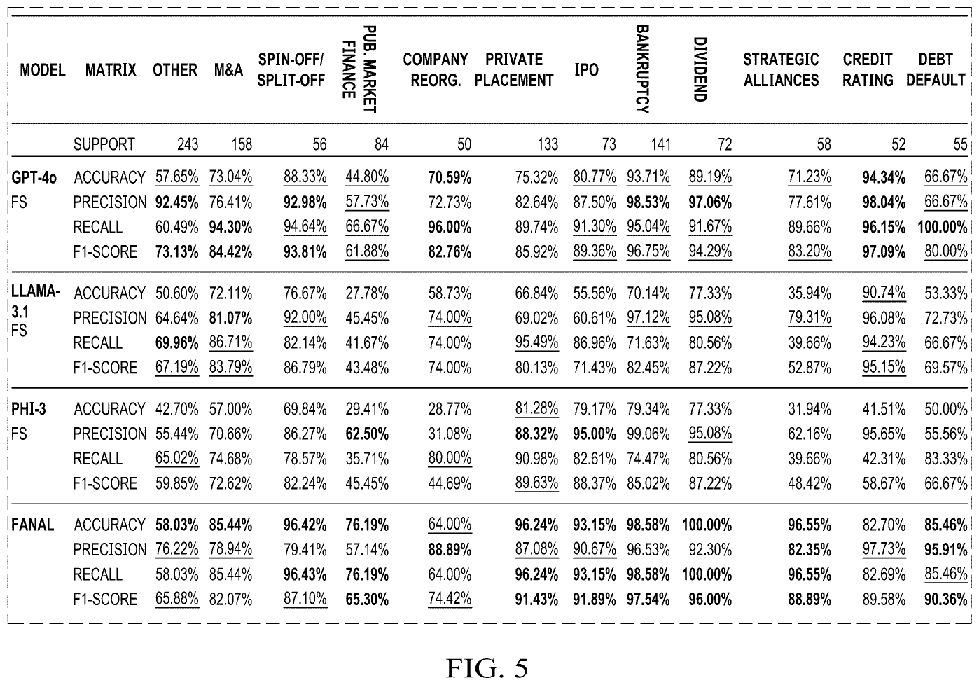

With reference now to FIG. 6, a flowchart illustrating a process for generating a model for classifying news article is shown in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in model manager 220 in computer system 204 in FIG. 2.

The process begins by training a first classification model using a first training dataset (step 600). The process receives a number of news articles from a plurality of data sources (step 602). The process classifies the number of news articles using the first classification model to generate a second training dataset (step 604). The process trains a second classification model using the first training dataset and the second training dataset (step 606).

The process adjusts parameters for the second classification model based on a combination of optimization techniques to generate an improved classification model (step 608). The process terminates thereafter.

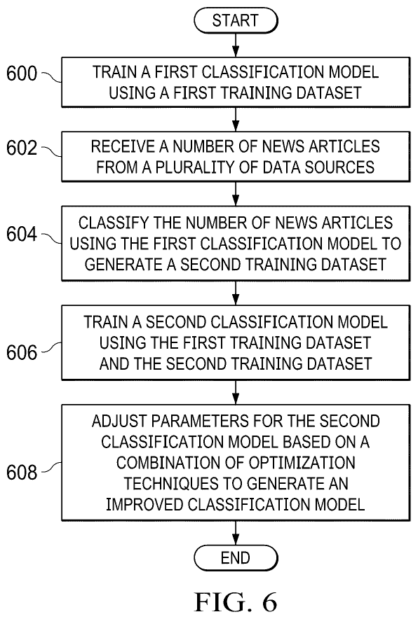

With reference now to FIG. 7, a flowchart illustrating a process for classifying news articles is shown in accordance with an illustrative embodiment. The process in this flowchart is an example of an implementation for step 604 in FIG. 6.

The process begins by determining a confidence threshold for the number of news articles (step 700). The process classifies each news article in the number of news articles into a number of categories with a confidence score (step 702).

The process generates the second training dataset based on the classification for the number of news articles (step 704). In step 704, the second training dataset includes news articles that have confidence scores that exceed the confidence threshold. The process terminates thereafter.

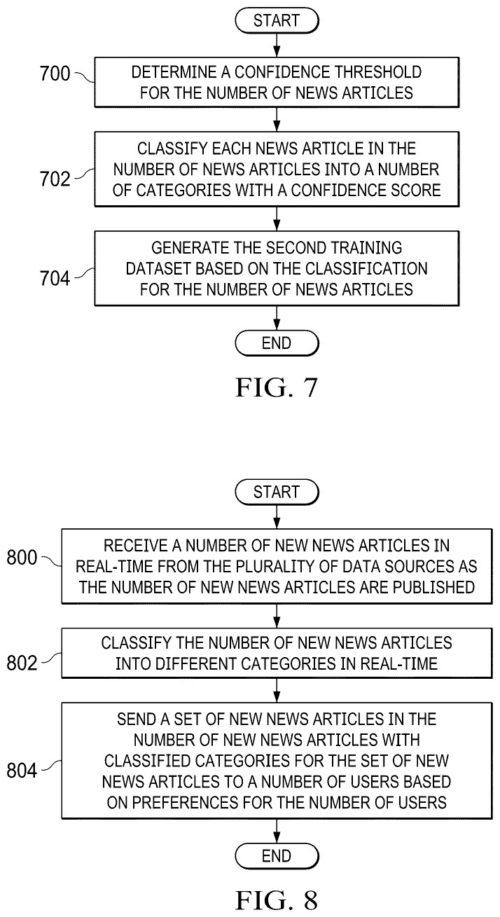

With reference now to FIG. 8, a flowchart illustrating a process for notifying users with classified articles is shown in accordance with an illustrative embodiment. The process in this figure is an example of an additional step that can be performed with the steps in FIG. 6.

The process begins by receiving a number of new news articles in real-time from the plurality of data sources as the number of new news articles are published (step 800). The process classifies the number of new news articles into different categories in real-time (step 802). The process sends a set of new news articles in the number of new news articles with classified categories for the set of new news articles to a number of users based on preferences for the number of users (step 804). The process terminates thereafter.

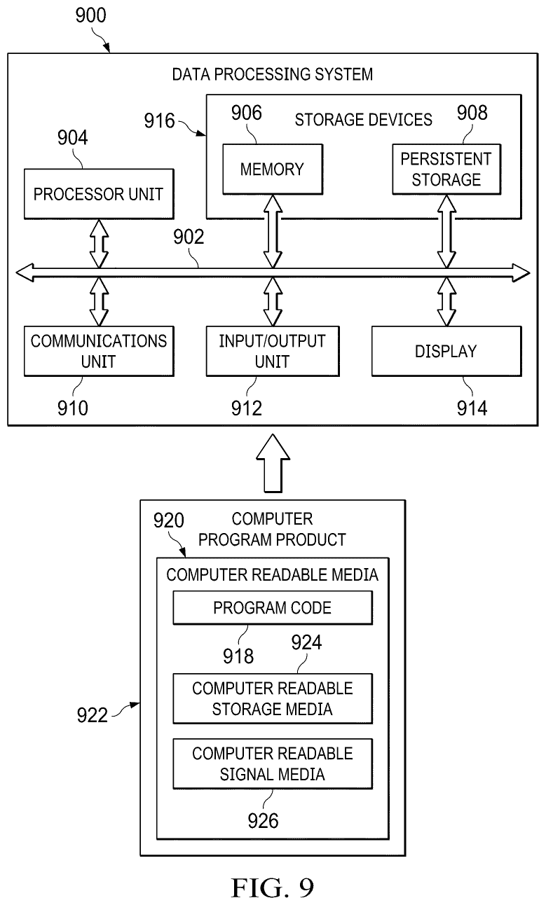

With reference now to FIG. 9, an illustration of a block diagram of a data processing system is depicted in accordance with an illustrative embodiment. Data processing system 900 may be used to implement server computer 104 and server computer 106 and client devices 110 in FIG. 1, as well as computer system 204 in FIG. 2. In this illustrative example, data processing system 900 includes communications framework 902, which provides communications between processor unit 904, memory 906, persistent storage 908, communications unit 910, input/output unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (GPUs).

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908. Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer-usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 918 may be transferred to data processing system 900 using computer-readable signal media 926. Computer-readable signal media 926 may be, for example, a propagated data signal containing program code 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method, comprising:
training, by a processor set, a first classification model using a first training dataset;
receiving, by the processor set, a number of news articles from a plurality of data sources;
classifying, by the processor set, the number of news articles using the first classification model to generate a second training dataset;
training, by the processor set, a second classification model using the first training dataset and the second training dataset; and
adjusting, by the processor set, parameters for the second classification model based on a combination of optimization techniques to generate an improved classification model.

2. The computer implemented method of claim 1, wherein the first classification model uses XGBoost algorithms.

3. The computer implemented method of claim 1, wherein the second classification model is a Bidirectional Encoder Representations from Transformers (BERT)-based language model.

4. The computer implemented method of claim 1, wherein the combination of optimization techniques comprises at least two of:
a first optimization technique for adjusting parameters in all layers of the second classification model to perform classification for news articles;
a second optimization technique for optimizing loss function for the second classification model; and
a third optimization technique for adjusting a portion of parameters in the second classification model while keeping other parameters fixed in the second classification model.

5. The computer implemented method of claim 4, wherein the second optimization technique optimizes loss function for the second classification model by incorporating an odds-ratio based penalty with negative log-likelihood (NLL) loss.

6. The computer implemented method of claim 1, wherein the improved classification model is a BERT-based model fine-tuned with Odds Ratio Preference Optimization (ORBERT).

7. The computer implemented method of claim 1, wherein the classifying, by the processor set, the number of news articles using the first classification model to generate the second training dataset comprising:
determining, by the processor set, a confidence threshold for the number of news articles;
classifying, by the processor set, each news article in the number of news articles into a number of categories with a confidence score; and
generating, by the processor set, the second training dataset based on the classification for the number of news articles, wherein the second training dataset comprises news articles that have confidence scores that exceed the confidence threshold.

8. The computer implemented method of claim 1, further comprising:
receiving, by the processor set, a number of new news articles in real-time from the plurality of data sources as the number of new news articles are published;
classifying, by the processor set, the number of new news articles into different categories in real-time; and
sending, by the processor set, a set of new news articles in the number of new news articles with classified categories for the set of new news articles to a number of users based on preferences for the number of users.

9. A computer system, comprising:
a processor set;
a set of one or more computer-readable storage media; and
program instructions stored on the set of one or more storage media to cause the processor set to perform operations comprising:
training a first classification model using a first training dataset;
receiving a number of news articles from a plurality of data sources;
classifying the number of news articles using the first classification model to generate a second training dataset;
training a second classification model using the first training dataset and the second training dataset; and
adjusting parameters for the second classification model based on a combination of optimization techniques to generate an improved classification model.

10. The computer system of claim 9, wherein the first classification model uses XGBoost algorithms.

11. The computer system of claim 9, wherein the second classification model is a Bidirectional Encoder Representations from Transformers (BERT)-based language model.

12. The computer system of claim 9, wherein the combination of optimization techniques comprises at least two of:
a first optimization technique for adjusting parameters in all layers of the second classification model to perform classification for news articles;
a second optimization technique for optimizing loss function for the second classification model; and
a third optimization technique for adjusting a portion of parameters in the second classification model while keeping other parameters fixed in the second classification model.

13. The computer system of claim 12, wherein the second optimization technique optimizes loss function for the second classification model by incorporating an odds-ratio based penalty with negative log-likelihood (NLL) loss.

14. The computer system of claim 9, wherein the improved classification model is a BERT-based model fine-tuned with Odds Ratio Preference Optimization (ORBERT).

15. The computer system of claim 9, wherein the classifying the number of news articles using the first classification model to generate the second training dataset comprising:
determining a confidence threshold for the number of news articles;
classifying each news articles in the number of news articles into a number of categories with a confidence score; and
generating the second training dataset based on the classification for the number of news articles, wherein the second training dataset comprises news articles that have confidence scores that exceed the confidence threshold.

16. The computer system of claim 9, wherein the operations further comprise:
receiving a number of new news articles in real-time from the plurality of data sources as the number of new news articles are published;
classifying the number of new news articles into different categories in real-time; and
sending a set of new news articles in the number of new news articles with classified categories for the set of new news articles to a number of users based on preferences for the number of users.

17. A computer program product comprising:
a set of one or more computer-readable storage media;
program instructions stored in the set of one or more storage media to perform operations comprising:
training, by a processor set, a first classification model using a first training dataset;
receiving, by the processor set, a number of news articles from a plurality of data sources;
classifying, by the processor set, the number of news articles using the first classification model to generate a second training dataset;
training, by the processor set, a second classification model using the first training dataset and the second training dataset; and
adjusting, by the processor set, parameters for the second classification model based on a combination of optimization techniques to generate an improved classification model.

18. The computer program product of claim 17, wherein the first classification model uses XGBoost algorithms.

19. The computer program product of claim 17, wherein the second classification model is a Bidirectional Encoder Representations from Transformers (BERT)-based language model.

20. The computer program product of claim 17, wherein the combination of optimization techniques comprises at least two of:
a first optimization technique for adjusting parameters in all layers of the second classification model to perform classification for news articles;
a second optimization technique for optimizing loss function for the second classification model; and
a third optimization technique for adjusting a portion of parameters in the second classification model while keeping other parameters fixed in the second classification model.

21. The computer program product of claim 20, wherein the second optimization technique optimizes loss function for the second classification model by incorporating an odds-ratio based penalty with negative log-likelihood (NLL) loss.

22. The computer program product of claim 17, wherein the improved classification model is a BERT-based model fine-tuned with Odds Ratio Preference Optimization (ORBERT).

23. The computer program product of claim 17, wherein the operations further comprise:
receiving, by the processor set, a number of new news articles in real-time from the plurality of data sources as the number of new news articles are published;
classifying, by the processor set, the number of new news articles into different categories in real-time; and
sending, by the processor set, a set of new news articles in the number of new news articles with classified categories for the set of new news articles to a number of users based on preferences for the number of users.
